(19) United States
(12) Patent Application Publication
(10) Pub. No.: US 2004/0189899 A1
(43) Pub. Date: Sep. 30, 2004

(54) Semitransparent liquid crystal display

(76) Inventor: Po Hsien Wang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/394,184

(22) Filed: Mar. 24, 2003

(51) Int. Cl. G02F 1/1335

(52) U.S. Cl. 349/114; 349/106

(57) ABSTRACT

A semitransparent liquid crystal display includes a liquid crystal module including an upper and a lower transparent substrates and a liquid crystal layer sandwiched between the upper and lower transparent substrates. A dielectric layer, a reflective layer, a color filtering film and a covering film are laid on the lower transparent substrate. The color filtering film has numerous red sub-pixels, green sub-pixels and blue sub-pixels arranged in a checker pattern. The reflective layer is formed with multiple openings. The openings of two adjacent rows are parallelly displaced and interlaced. The openings are arranged respectively corresponding to the sub-pixels of the color filtering film.

### BACKGROUND OF THE INVENTION

The present invention is related to a semitransparent liquid crystal display in which a color filtering film has numerous sub-pixels arranged in a mosaic-like pattern. A reflective layer is formed with multiple openings arranged respectively corresponding to the sub-pixels of the color filtering film. The semitransparent liquid crystal display can achieve the same display effect as the mosaic-type display.

FIG. 5 shows the pixels of the color filtering film of a conventional liquid crystal display, which are arranged in a mosaic pattern. Numerous red (R) sub-pixels 31, green (G) sub-pixels 32 and blue (B) sub-pixels 33 are arranged in mosaic pattern. FIG. 6 shows the connection of a conventional mosaic-type electrode. The longitudinal adjacent sub-pixels are provided with data electrode connecting wires 34 which are longitudinally parallelly arranged. Each data electrode connecting wire 34 must pass through the pitch 35 between two adjacent sub-pixels of a transverse row to connect with a longitudinally spaced sub-pixel. Each transverse row of sub-pixels is connected together by a parallel scanning electrode connecting wire 36. The data electrode connecting wires 34 and the scanning electrode connecting wire 36 are connected with a driving element (not shown) disposed on the edge of the display. The driving element serves to control driving signal and scan the respective sub-pixels to form the picture.

According to the above data transmission wire layout, when arranging the sub-pixels on the panel of the display, a passage must be reserved between a left and a right sub-pixels adjacent to each other, whereby the data electrode connecting wires 34 can pass through the passage. As a result, the pitch between the left and right sub-pixels cannot be minified so that the resolution of the display can be hardly enhanced. Accordingly, the area of display pixels is limited and the ratio of the openings is reduced. Such data electrode connecting wire layout makes the driving module have higher impedance and leads to distortion of signal and cross-talk. In addition, the displayed straight line will be saw-toothed. Therefore, the display effect is poor.

FIG. 7 shows the layout of the electrode connecting wires of the pixel driving module of a conventional liquid crystal display. Each transverse row of sub-pixels is connected together by a parallel scanning electrode connecting wire 36. The data electrode connecting wires are arranged in a saw-toothed pattern. The saw-toothed electrodes are characterized in that a neck section 37 is formed between two electrodes connected with each other. The scanning electrode connecting wire longitudinally sequentially connects the sub-pixels of two adjacent transverse rows. The saw-toothed data electrode connecting wire layout solves the above problem and shortens the pitch between the sub-pixels. The area of the display pixels and the ratio of the openings are increased. Therefore, the resolution of the display is enhanced.

However, such structure has some shortcomings as follows: As shown in FIG. 8, the neck section 37 of the saw-toothed electrodes has a reduced width at the connecting section between the pixels. As a result, the impedance of the electrode is increased and cross-talk is very likely to take place. In yellow light manufacturing procedure, because the width of the connecting wire is reduced at the saw-toothed section, it is difficult to manufacture the saw-toothed electrode pattern. Therefore, the ratio of good products is lowered and the cost is increased.

Moreover, the electrodes are arranged in an irregular pattern so that it is impossible to manufacture the color filtering film with one piece of optical mask by parallel displacement exposure. Instead, it is necessary to use multiple pieces of optical masks to expose at many times. This leads to increment of manufacturing cost.

### SUMMARY OF THE INVENTION

It is therefore a primary object of the present invention to provide a semitransparent liquid crystal display. In the existent same driving condition, the same display effect can be achieved. Moreover, the impedance of the electrode is reduced and the cross-talk is minified. The ratio of good products is increased and the cost for the optical mask is lowered.

It is a further object of the present invention to provide a driving module of a liquid crystal display by which the resolution of the image of the display is enhanced and the area of the display pixels and the ratio of openings are increased.

According to the above objects, the semitransparent liquid crystal display of the present invention includes:

an upper transparent substrate, an upper deflecting plate being laid on one face of the upper transparent substrate, an upper transparent electrode being laid on the other face of the upper transparent substrate;

a lower transparent substrate, a lower deflecting plate being laid on one face of the lower transparent substrate, a lower transparent electrode being laid on the other face of the lower transparent substrate, a liquid crystal layer being sandwiched between the upper and lower transparent substrates; and

a dielectric layer, a reflective layer, a color filtering film and a covering film sequentially piled between the lower transparent substrate and the lower transparent electrode. The color filtering film has numerous red sub-pixels, green sub-pixels and blue sub-pixels arranged in a mosaic-like manner. The reflective layer is formed with multiple openings. The openings of two adjacent rows are parallelly displaced and interlaced. The openings are arranged respectively corresponding to the sub-pixels of the color filtering film. The covering film is overlaid on the color filtering film. The lower transparent electrode is laid on the covering film corresponding to the position of each sub-pixel of the color filtering film.

The present invention can be best understood through the following description and accompanying drawings wherein:

### BRIEF DESCRIPTION OF THE DRAWINGS

FIG. 1 shows that the pixels of the color filtering film of the present invention are arranged in a mosaic-like pattern;

FIG. 2 shows the structure of the reflective layer of the present invention;

FIG. 3 shows the structure of the reflective layer and color filtering film of the present invention;

FIG. 4 is a sectional view of the structure of the present invention;

FIG. 5 shows that the pixels of the conventional liquid crystal display are arranged in a mosaic pattern;

FIG. 6 shows a type of connection of the electrodes of the conventional mosaic liquid crystal display;

FIG. 7 shows another type of connection of the electrodes of the conventional mosaic liquid crystal display; and

FIG. 8 shows the conventional saw-toothed data electrodes.

### DETAILED DESCRIPTION OF THE PREFERRED EMBODIMENT

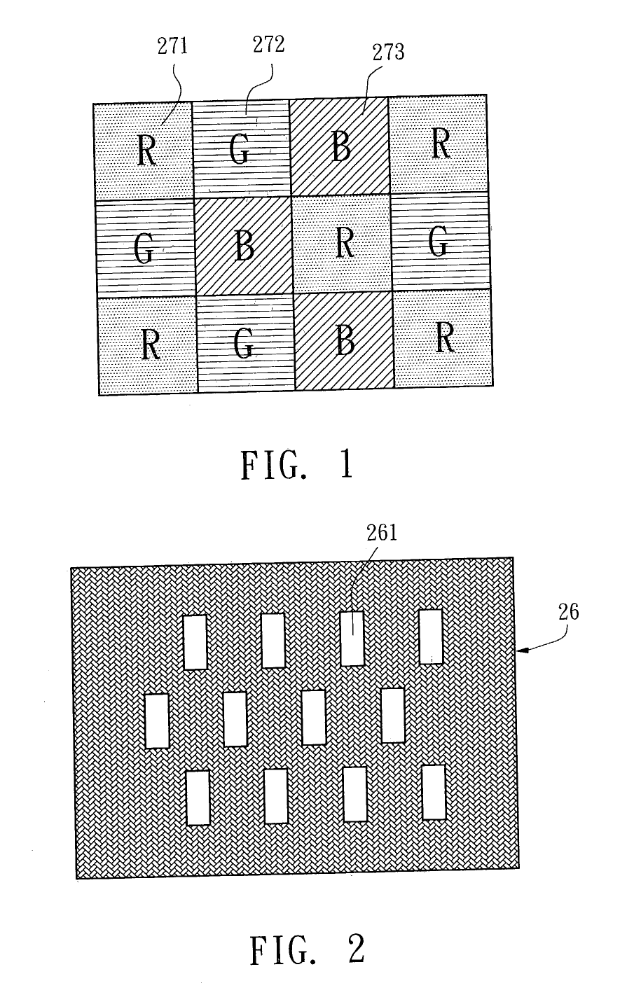

Please refer to FIGS. 1 to 4. The semitransparent liquid crystal display of the present invention has a liquid crystal module including an upper transparent substrate 11 and a lower transparent substrate 21.

An upper deflecting plate 12 is laid on one face of the upper transparent substrate 11. An upper transparent electrode 13 is laid on the other face of the upper transparent substrate 11.

A lower deflecting plate 22 is laid on one face of the lower transparent substrate 21. A lower transparent electrode 23 is laid on the other face of the lower transparent substrate 21. A liquid crystal layer 24 is sandwiched between the upper and lower transparent substrates 11, 21. In this embodiment, the upper and lower transparent electrodes 13, 23 are made by way of vacuum plating and patterned into the necessary electrodes by means of yellow light manufacturing procedure.

Between the lower transparent substrate 21 and the lower transparent electrode 23 are sequentially piled a dielectric layer 25, a reflective layer 26, a color filtering film 27 and a covering film 28. In this embodiment, the material dielectric layer 25 includes a composition of inorganic Si oxide, Ti oxide, etc. The material of the reflective layer 26 is a metal conductive material mainly including silver and aluminum. The color filtering film 27 has numerous red sub-pixels 271, green sub-pixels 272 and blue sub-pixels 273. The sub-pixels are arranged in a mosaic-like periodical manner. The sub-pixels of two adjacent rows are arranged in a mosaic-like manner in alignment with each other. The reflective layer 26 is formed with multiple openings 261. The openings 261 of two adjacent rows are parallelly displaced and interlaced. The openings 261 are arranged respectively corresponding to the sub-pixels of the color filtering film 27. The covering film 28 is overlaid on the color filtering film 27. The lower transparent electrode 23 is laid on the covering film 28 corresponding to the position of each sub-pixel.

In penetration mode of the semitransparent liquid crystal display of the present invention, the incident backlight goes into the lower deflecting plate 22 through the lower transparent substrate 21 and the openings 261 of the reflective layer 26. As shown in FIG. 2, the openings 261 are arranged as a mosaic structure. After the light goes into the color filtering film 27, the light is filtered. After the light penetrates through the covering film 28 and the lower transparent electrode 23, the light goes through the liquid crystal layer 24. Under the electric field effect of the lower and upper transparent electrodes 23 and 13, the liquid crystal layer 24 is twisted so that after the light goes through the liquid crystal layer 24, the color gradation changes. Finally, the light passes through the upper transparent electrode 13 and the upper transparent substrate 11 and the upper deflecting plate 12 and goes out therefrom to form an image. By means of such pattern, relative positions of the sub-pixels completely the same as the mosaic-arranged display can be obtained to provide the same display effect.

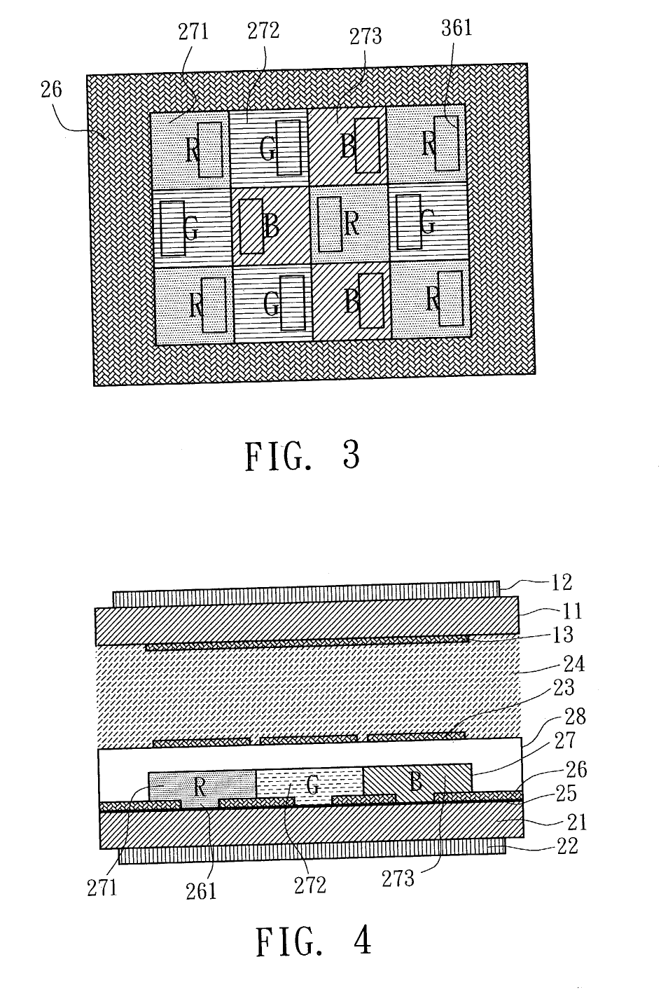

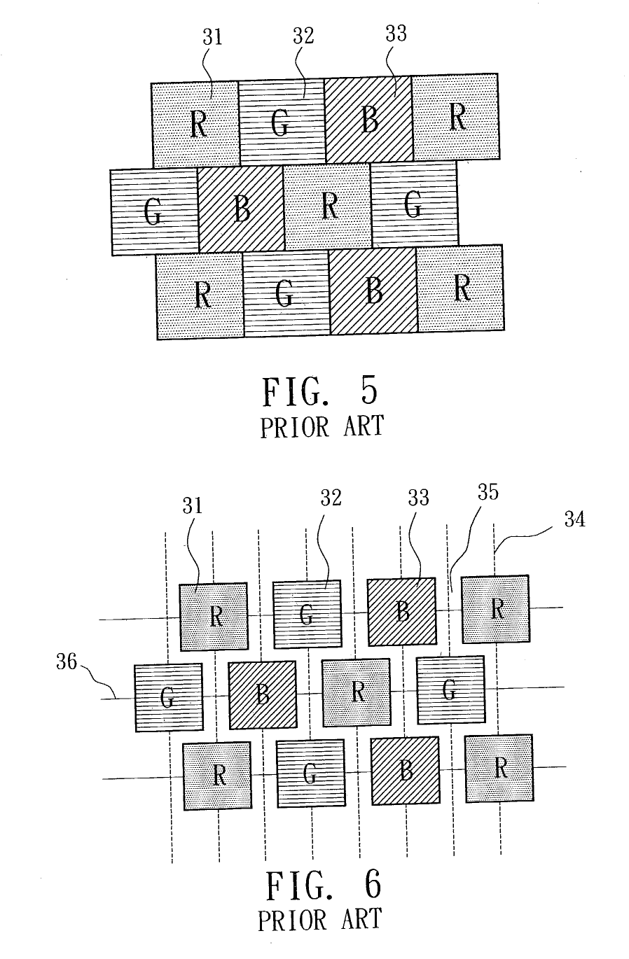

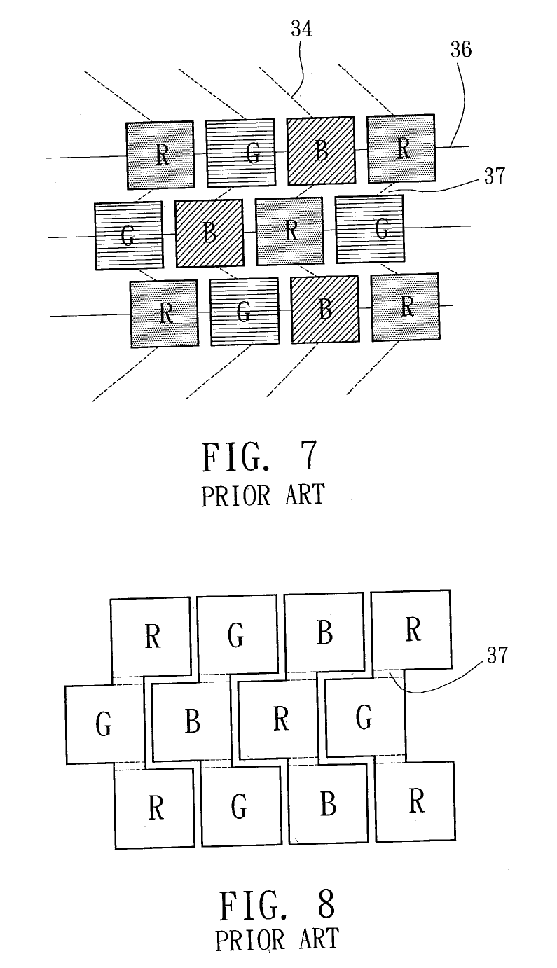

Referring to FIG. 3, according to the design of the present invention, a straight bar type data electrode can be made. Therefore, in the existent same driving mode, a display effect completely the same as the mosaic-arranged display can be achieved. Moreover, the straight bar type data electrode can reduce the impedance of the electrode and minify cross-talk phenomenon. This because the reflective opening design avoids the saw-toothed data electrode of the layout of the electrode connecting wire of the conventional liquid crystal display pixel driving module. Therefore, the data electrode of the present invention has larger width and the ratio of good products is increased in yellow light manufacturing procedure to provide better character pattern display.

In reflection mode of the semitransparent liquid crystal display of the present invention, referring to FIG. 4, the light is reflected by the reflective layer 26. The reflective layer 26 has openings 261 so that the reflective face of the reflective layer 26 is complementary to the above penetration mode. Accordingly, after the light goes into the color filtering film 27, the light is filtered. After the light penetrates through the covering film 28 and the lower transparent electrode 23, the light goes through the liquid crystal layer 24. Under the electric field effect of the lower and upper transparent electrodes 23 and 13, the liquid crystal layer 24 is twisted so that after the light goes through the liquid crystal layer 24, the color gradation changes. Finally, the light passes through the upper transparent electrode 13 and the upper transparent substrate 11 and the upper deflecting plate 12 and goes out therefrom to form an image. The reflection mode is only different from the mosaic type by ¾ pixel so that the affection on the display effect is limited. Therefore, a similar effect can be still achieved.

The above embodiment is only used to illustrate the present invention, not intended to limit the scope thereof. Many modifications of the above embodiment can be made without departing from the spirit of the present invention.

What is claimed is:

1. A semitransparent liquid crystal display having a liquid crystal module, comprising:
an upper transparent substrate, an upper deflecting plate being laid on one face of the upper transparent substrate, an upper transparent electrode being laid on the other face of the upper transparent substrate;
a lower transparent substrate, a lower deflecting plate being laid on one face of the lower transparent substrate, a lower transparent electrode being laid on the other face of the lower transparent substrate, a liquid crystal layer being sandwiched between the upper and lower transparent substrates; and
a dielectric layer, a reflective layer, a color filtering film and a covering film sequentially piled between the lower transparent substrate and the lower transparent electrode, the color filtering film having numerous red sub-pixels, green sub-pixels and blue sub-pixels arranged in a mosaic-like manner, the reflective layer being formed with multiple openings, the openings of two adjacent rows being parallelly displaced and interlaced, the openings being arranged respectively corresponding to the sub-pixels of the color filtering film, the covering film being overlaid on the color filtering film, the lower transparent electrode being laid on the covering film corresponding to the position of each sub-pixel of the color filtering film.

2. The semitransparent liquid crystal display as claimed in claim 1, wherein the upper and lower transparent electrodes are made by way of vacuum plating.

3. The semitransparent liquid crystal display as claimed in claim 1, wherein the material of the reflective layer is a metal conductive material mainly including silver and aluminum.

4. The semitransparent liquid crystal display as claimed in claim 1, wherein the upper and lower transparent electrodes are patterned into necessary electrodes by means of yellow light manufacturing procedure.

5. The semitransparent liquid crystal display as claimed in claim 1, wherein the openings of the reflective layer are formed by etching by means of yellow light manufacturing procedure, the openings of two adjacent rows being parallelly displaced and interlaced.

6. The semitransparent liquid crystal display as claimed in claim 1, wherein the pixels of the color filtering film include red, green and blue periodical wave filters.

7. The semitransparent liquid crystal display as claimed in claim 1, wherein the pixels of the color filtering film are arranged in a mosaic-like manner.

8. The semitransparent liquid crystal display as claimed in claim 4, wherein the material dielectric layer includes a composition of inorganic Si oxide, Ti oxide, etc.
